(19) United States
(12) Patent Application Publication
(10) Pub. No.: US 2024/0098584 A1
(43) Pub. Date: Mar. 21, 2024

(54) METHODS, INFRASTRUCTURE EQUIPMENT AND COMMUNICATIONS DEVICES

(71) Applicant: Sony Group Corporation, Tokyo (JP)

(72) Inventors: Vivek SHARMA, Basingstoke (GB); Hideji WAKABAYASHI, Basingstoke (GB); Yuxin WEI, Basingstoke (GB); Yassin Aden AWAD, Basingstoke (GB)

(73) Assignee: Sony Group Corporation, Tokyo (JP)

(21) Appl. No.: 18/272,804

(22) PCT Filed: Jan. 18, 2022
(86) PCT No.: PCT/EP2022/051040

§ 371 Date: Jul. 18, 2023

(30) Foreign Application Priority Data
Feb. 3, 2021 (EP) 21155091.8

(51) Int. Cl. H04W 36/00

(52) U.S. Cl. CPC H04W 36/0044; H04W 36/0058; H04W 84/12

(57) ABSTRACT

A method for providing service continuity in a handover of a communications device from an untrusted access point to a trusted access point in a wireless communications network includes transmitting a request to receive a service from a core network of the wireless communications network via the untrusted access point, the communications device being in an inactive state; receiving from the untrusted access point the requested service using a current communications session; determining that a handover procedure should be performed from the untrusted access point to the trusted access point; arranging for the trusted access point to receive information regarding the current communications session in advance of the handover, the information including at least an indication that the communications device is currently receiving the requested service via the untrusted access point; receiving the requested service from the core network via the trusted access point after the handover.

### BACKGROUND

### Field of Disclosure

The present disclosure relates to communications devices, infrastructure equipment and methods of operating by a communications device in a wireless communications network.

The present invention claims the Paris Convention priority from European patent application number EP21155091.8, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Present and future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running.

In view of this there is expected to be a desire for present and future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and communications devices can give rise to new challenges. For example, one such challenge may be ensuring service continuity for a communications device being handed over from an untrusted access point of a 5G core network to a trusted access point of a 5G core network

### SUMMARY OF THE DISCLOSURE

The present disclosure can help address or mitigate at least some of the issues discussed above.

According to one aspect, disclosed embodiments of the present technique can provide a method performed by a communications device for providing service continuity in a handover of a communications device from an untrusted access point to a trusted access point in a wireless communications network. The method comprises transmitting, by transceiver circuitry of the communications device to the untrusted access point, a request to receive a service from a core network of the wireless communications network via the untrusted access point, the communications device being in an inactive state in which it retains a context from a previous communications session with the core network via the trusted access point; receiving, by the transceiver circuitry of the communications device from the untrusted access point, the requested service from the core network via the untrusted access point using a current communications session; determining, by the communications device, that a handover procedure should be performed for the communications device from the untrusted access point to the trusted access point; arranging, by the communications device, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point; receiving, by the transceiver circuitry of the communications device, the requested service from the core network via the trusted access point after the handover of the communications device from the untrusted access point to the trusted access point.

According to another aspect, disclosed embodiments of the present technique can provide a method performed by circuitry of a core network for providing service continuity in a handover of the communications device from an untrusted access point to a trusted access point in a wireless communications network. The method comprises receiving, by transceiver circuitry of the core network of the wireless communications network from the communications device via the untrusted access point, a request to receive a service from the core network via the untrusted access point, the communications device being in an inactive state in which it retains a context from a previous communications session with the core network via the trusted access point; providing by the transceiver circuitry of the core network to the communications device via the untrusted access point, the requested service using a current communications session; determining, by the core network, that a handover procedure should be performed for the communications device from the untrusted access point to the trusted access point; arranging, by the core network, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point; providing, by the transceiver circuitry of the core network, the requested service to the communications device via the trusted access point after the handover of the communications device from the untrusted access point to the trusted access point.

According to another aspect, disclosed embodiments of the present technique can provide a method performed by a trusted access point for providing service continuity in a handover of a communications device from an untrusted access point to the trusted access point in a wireless communications network. The method comprises determining, by the trusted access point, that a handover procedure should be performed for the communications device from the untrusted access point to the trusted access point; receiving, by transceiver circuitry of the trusted access point, information regarding a current communications session used for providing a requested service from the core network to the communications device via the untrusted access point in advance of a handover of the communications device between the untrusted and trusted access points, the information regarding the current communications session including at least an indication that the communications device is currently receiving the requested service via the untrusted access point; providing, by the transceiver circuitry of the trusted access point, the requested service from the core network via the trusted access point after the handover of the communications device from the untrusted access point to the trusted access point.

According to another aspect, disclosed embodiments of the present technique can provide a method performed by an untrusted access point for providing service continuity in a handover of a communications device from the untrusted access point to a trusted access point in a wireless communications network. The method comprises receiving, by transceiver circuitry of the untrusted access point from the communications device, a request to receive a service from a core network of the wireless communications network via the untrusted access point, the communications device being in an inactive state in which it retains a context from a previous communications session with the core network via the trusted access point; providing, by the transceiver circuitry of the untrusted access point to the communications device, the requested service from the core network via the untrusted access point using a current communications session; determining, by the untrusted access point, that a handover procedure should be performed for the communications device from the untrusted access point to the trusted access point; arranging, by the untrusted access point, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 is a schematic diagram illustrating a Public Network Integrated Non Public Network (PNI-NPN);

FIG. 5a is a schematic diagram illustrating a Public Land Mobile Network (PLMN) and a Standalone Non-Public Network (SNPN) with separate core networks;

FIG. 5b is a schematic diagram illustrating a Public Land Mobile Network (PLMN) and a Standalone Non-Public Network (SNPN) with a common User Plane Function (UPF);

FIG. 6 is a schematic diagram illustrating shows how data radio bearers, QoS flows and protocol data units are mapped throughout a radio access network;

FIG. 7 is a schematic diagram illustrating various Radio Resource Control (RRC) states which may be occupied by a communications device in a 5G NR wireless communications network;

FIG. 8 is a flow diagram illustrating an RRC Resume Procedure in which a communications device transitions from an RRC_INACTIVE state to an RRC_CONNECTED state;

FIG. 9 is a flow diagram illustrating an RRC Resume Procedure in which a communications device in an RRC_INACTIVE is instructed to remain in the RRC_INACTIVE state;

FIG. 10 is a schematic diagram illustrating a communications device communicating with a core network via a trusted access point in accordance with exemplary embodiments;

FIG. 11 is a schematic diagram illustrating a communications device communicating with a core network via an untrusted access point in accordance with exemplary embodiments;

FIG. 12 is a schematic diagram illustrating a simplified representation of the protocol stacks present in the devices of FIGS. 10/11;

FIG. 13 is a flow diagram illustrating a communications procedure in which service continuity is ensured for a handover between an untrusted and trusted access point in accordance with exemplary embodiments;

FIG. 14 is a flow diagram illustrating a communications procedure in which service continuity is ensured for a handover between an untrusted and trusted access point in accordance with exemplary embodiments;

FIG. 15 is a flow diagram illustrating a communications procedure in which service continuity is ensured for a handover between an untrusted and trusted access point in accordance with exemplary embodiments;

FIG. 16 is a flow diagram illustrating steps performed by a communications device according to example embodiments of a method for providing service continuity in a handover of the communications device from an untrusted access point to a trusted access point in a wireless communications network;

FIG. 17 is a flow diagram illustrating steps performed by circuitry in a core network according to example embodiments of a method for providing service continuity in a handover of a communications device from an untrusted access point to a trusted access point in a wireless communications network;

FIG. 18 is a flow diagram illustrating steps performed by a trusted access point according to example embodiments of a method for providing service continuity in a handover of a communications device from an untrusted access point to the trusted access point in a wireless communications network; and

FIG. 19 is a flow diagram illustrating steps performed by a untrusted access point according to example embodiments of a method for providing service continuity in a handover of a communications device from the untrusted access point to a trusted access point in a wireless communications network.

### DETAILED DESCRIPTION OF THE EMBODIMENTS

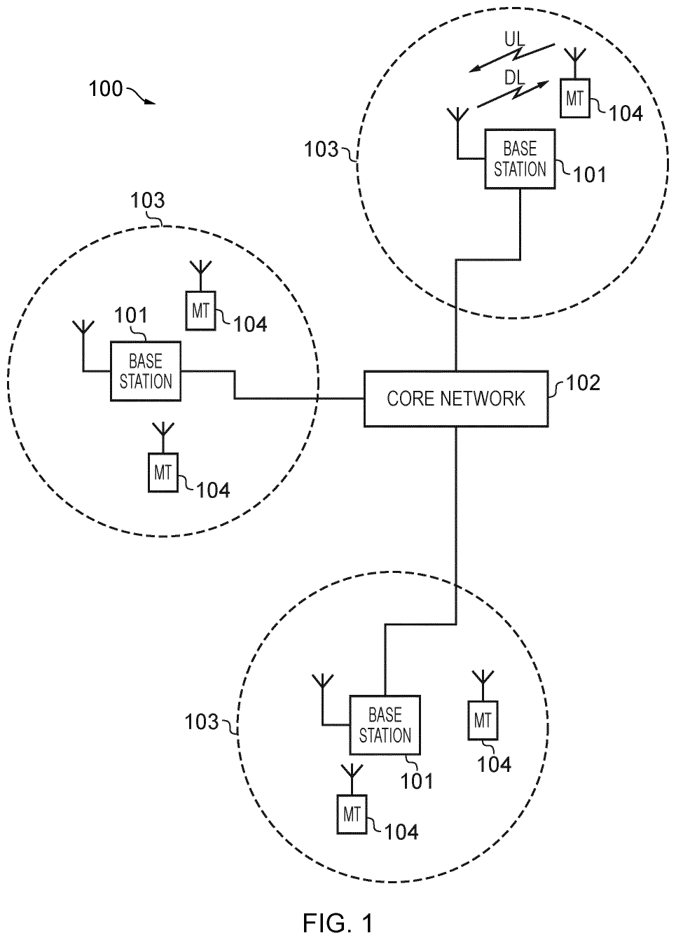

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

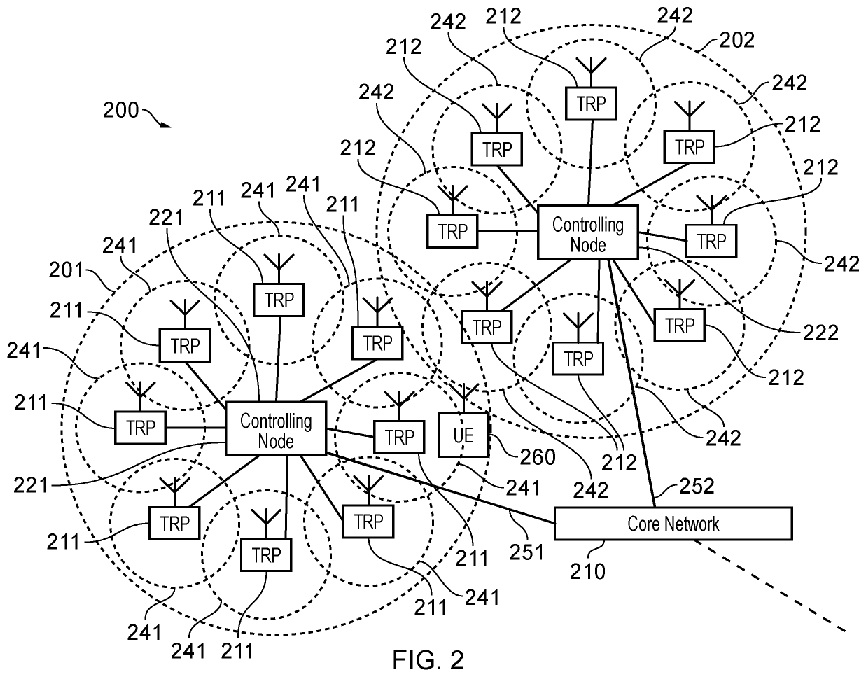

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

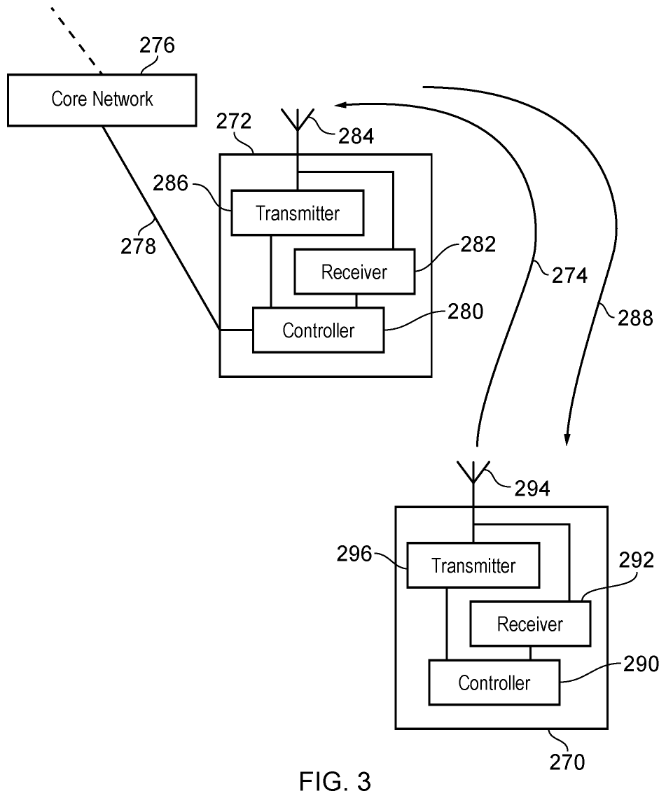

A more detailed illustration of a communications device 270 and an example network infrastructure equipment 272, which may be thought of as a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus, the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random-access memory, which may be non-volatile memory, operating according to instructions stored on a computer readable medium.

In FIG. 3, the infrastructure equipment 272 provides the communications device 270 with access to the core network 276. The infrastructure equipment 272 may be regarded as a “trusted access point” to the core network 276 from the perspective of an operator who controls, owns or is otherwise responsible for the infrastructure equipment 272. For example, the operator may be responsible for deploying the infrastructure equipment 272. However, if the infrastructure equipment 272 is deployed in a location not controlled or owned by the operator (for example, if the infrastructure equipment 272 is a residential gateway implementing WiFi protocols in the home of a private individual or a stand alone non public network (SNPN) in a factory not owned by the operator for example), then the infrastructure equipment 272 may be regarded as an “untrusted access point” to the core network 276 from the perspective of the operator.

The deployment of 5G ‘non-public networks’ (NPN) provides support for 5G services such as URLLC, eMBB and mMTC in a private network. In an NPN, the reliability and latency of communications may be increased because 5G network functions are physically closer to communications devices accessing the 5G services. Additionally, NPNs provide increased security over public networks and the operator of the network has greater control over the authorisation of the communications devices in the network. Examples of NPNs are Public Network Integrated-Non Private Networks (PNI-NPN) and SNPN which are explained below.

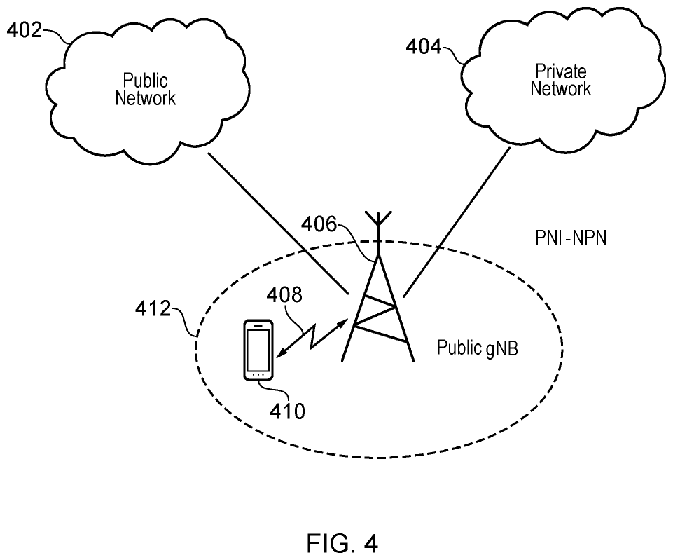

FIG. 4 illustrates an example of a PNI-NPN. In FIG. 4, a communications device 410 (which may be an example of UE 270) is performing communication over a radio link 408 with either a private core network 404 or a public core network 402 via a gNB 406. In PNI-NPNs, as illustrated in FIG. 4, the gNB 406 is connected to both the private network 404 and the public network 402, meaning that the gNB 406 is a common access point to the private network 404 and the public network 402.

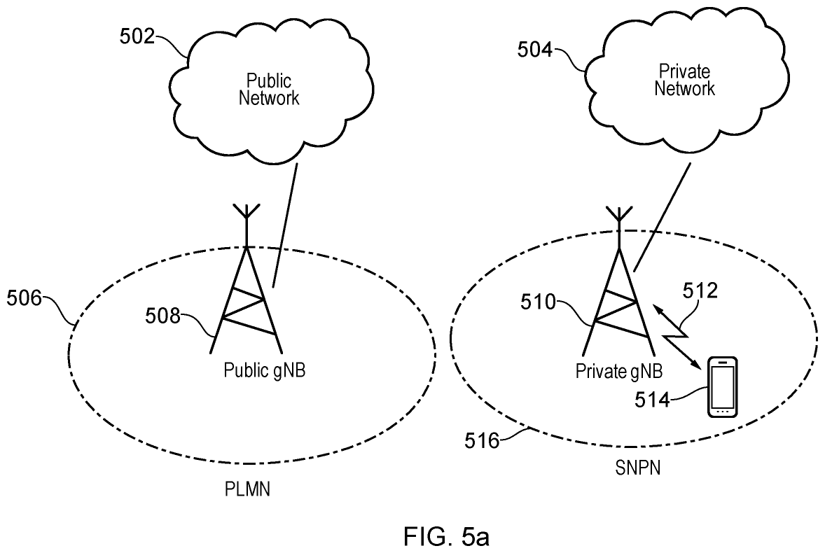

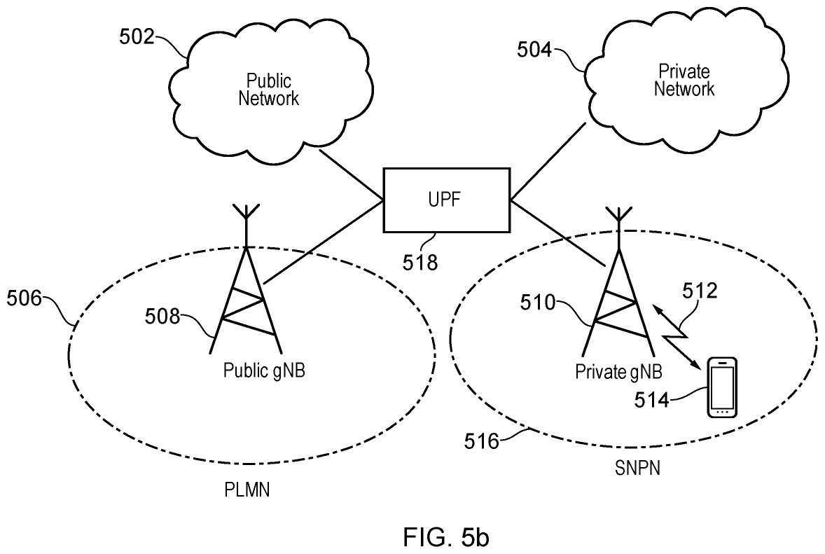

By contrast, FIG. 5a illustrates an example of an SNPN. In FIG. 5a, a communications device 514 is performing communication over a radio link 512 with a private core network 502 via a private gNB 510. In this example, the private gNB 510 is connected to the private core network 504 but is not connected to the public core network 502 (which has its own public gNB 508). In this example, an operator may be responsible for the public gNB 508, and a second different person/company may be responsible for the private gNB 510. In this example, the private gNB 510 may be regarded as an untrusted access point from the perspective of the operator.

In some examples, SNPN may share the core network 502 with the PLMN. In other examples, the SNPN may share part of the core network 502 with the PLMN. For example, as illustrated in FIG. 5b, the PLMN and SNPN may share a common User Plane Function (UPF) 518 for establishing Multi-Access PDU (MA-PDU sessions) as explained below.

In some examples, an SNPN uses physically distinct radio spectrum and subscriber database from the public network 502. A SNPN may link to the public network 502 via an edge node with a firewall (to provide access to, for example, voice services).

5G supports UEs establishing multiple Protocol Data Unit (PDU) sessions to the same data network or to different data networks over a single or multiple access networks including trusted and non-trusted accesses points. Such sessions are known as “Multi-Access PDU (MA-PDU) sessions”. Session establishment procedures for MA-PDUs are described in [2].

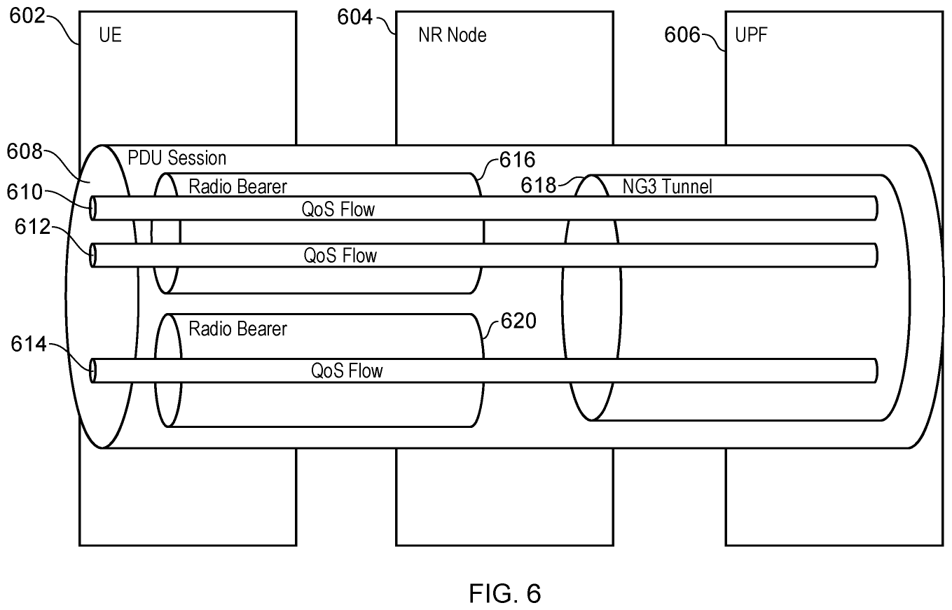

FIG. 6 shows how data radio bearers, QoS flows and protocol data units (PDUs) are mapped throughout a radio access network comprising a UE 602 and NR node 604 (for example a trusted or untrusted access point to the core network). Also shown in FIG. 6 is a network function of a 5G core network known as a User Plane Function 606 (UPF). The UPF 606 is responsible for packet routing and forwarding, packet inspection, QoS handling, and external PDU sessions for an interconnecting data network, in the 5G architecture as will be appreciated by one skilled in the art.

The UE 602 communicates with the UPF via a PDU session 608. Three QoS flows 610, 612, 614 belong to the PDU session 608, and are associated with radio bearers (DRB) 616 and 620. One PDU session may be mapped to one or more DRBs and one PDU session may have multiple QoS flows, and there could be multiple PDU sessions supported by the UE 602.

Each Internet Protocol (IP) packet received from the 5G core network may be assigned a particular QoS such as QoS flows 610, 612, 614. Each of the QoS flows may be characterised by a QoS flow ID and may be associated with a quality of service requirement (such as one or more of a Guaranteed Bit Rate (GBR), a maximum bit rate, a maximum latency, a permitted packet loss ratio and the like). Therefore the UE 602 is aware of the parameters associated with each of the QoS flows 610, 612, 614. The NR node 604 connected to the 5G core network is also aware of the QoS flows.

The NR node 604 establishes logical connections with the UE which may be DRBs 616 and 620. In accordance with a 5G system architecture as shown in FIG. 6, one DRB (such as the DRB 616) may be used to transport packet data associated with two QoS flows (such as the QoS flows 610 and 612). In order to accommodate this flexibility, the NR node 604 may maintain a mapping table to store a mapping between each of the QoS flows and the respective DRB. Using the table, the NR node 604 is able to assign packets received from the 5G core network over the QoS flows 610, 612, 614 to the appropriate data radio bearers 616, 620 for transmission to the UE 602.

For MA-PDUs, low QoS traffic may be split, switched and steered between trusted and untrusted access points according to Access Traffic Steering, Switching and Splitting (ATSSS) rules. However, for high QoS traffic, such GBR traffic, the high QoS should be maintained. Therefore GBR traffic may have only one active route at the same time. In other words, GBR traffic flows either via trusted or untrusted access but not both at the same time. ATSSS enhancements are described in [3].

In certain scenarios, a UE may be performing radio communication with the core network via an untrusted access point using an MA-PDU session. If the UE enters an inactive state, and is later handed over to a trusted access point, a technical problem arises in ensuring that the MA-PDU session can be maintained to ensure service continuity as explained below.

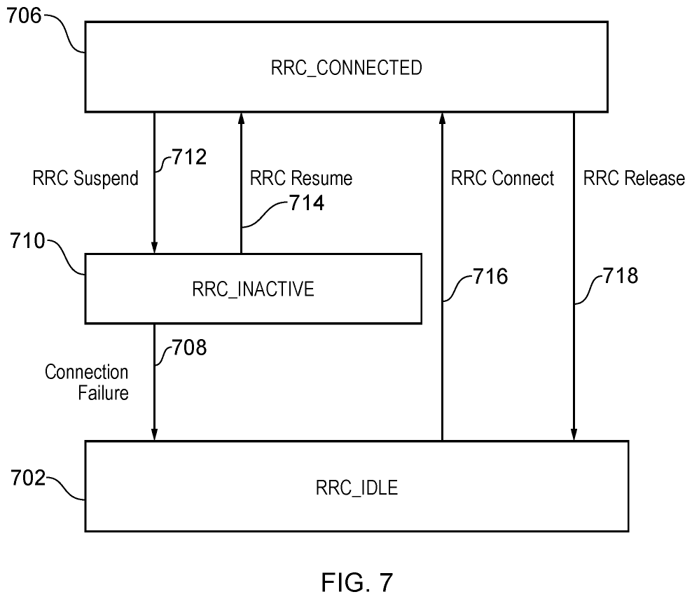

As shown in FIG. 7, a UE forming part of a NR wireless communications network may occupy one of three Radio Resource Control (RRC) states: the RRC_CONNECTED state 706 (referred to herein as the “connected state”), the RRC_INACTIVE state 710 (referred to herein as the “inactive state”) and the RRC_IDLE 702 state (referred to herein as the “idle state”).

In the idle state 702, the UE does not have dedicated resources and does not transmit or receive user data apart from performing actions necessary to manage its own mobility. The UE also performs monitoring for paging by monitoring broadcast signals transmitted on a Broadcast Control Channel (BCCH) by each gNB. The core network is aware of the UE's location within a Tracking Area and does not have the UE AS (access stratum) context and cannot schedule physical resources for user data transmission because the UE does not have a unique identifier within a cell (C-RNTI).

In the connected state 702, the UE has established an RRC connection and has dedicated resources for transmitting or receiving data. The core network is aware of the UE's location at the cell level and has the UE context thereby allowing scheduling of physical resources for user data transmissions because the UE has been assigned a temporary ID which is unique to that UE within the cell (C-RNTI) and hence the UE can be directly addressed by the core network.

In the inactive state 710, the UE can perform small data transmission with the wireless communication network. The core network will not be aware that the UE is in the inactive state and will therefore not release any tunnels which have been established between the UE and the core network when the UE was in the connected state 706.

In the inactive state 710, the UE retains access stratum (AS) context. Storing of AS context in the UE is specified in [4] as:

Store in the UE Inactive AS Context the current KgNB and KRRCint keys, the ROHC state, the stored QoS flow to DRB mapping rules, the C-RNTI used in the source PCell, the cellIdentity and the physical cell identity of the source PCell, the spCellConfigCommon within ReconfigurationWithSync of the NR PSCell (if configured) and all other parameters configured except for:
parameters within ReconfigurationWithSync of the PCell;
parameters within ReconfigurationWithSync of the NR PSCell, if configured;
parameters within MobilityControlInfoSCG of the E-UTRA PSCell, if configured;
servingCellConfigCommonSIB.

FIG. 7 illustrates how a UE may transition between the idle 702, inactive 710 and connected 706 states. If a UE in the idle state 702 establishes an RRC connection, the UE transitions from the idle 702 to the connected state 706 as shown by arrow 716. Conversely, a UE may transition from the connected state 706 to the idle state 702 by releasing its RRC connection (and hence releasing its C-RNTI) as shown by arrow 718.

A UE may transition from the connected state 706 to the inactive state if it receives an RRC suspend configuration message as shown by arrow 712. In this case, although the radio link between the UE and the base station in the connected state 706 is taken down for power conservation, the logical link to the Access Mobility and Management function (AMF) in the core network and the user data tunnel to the UPF remain in place. The core network is not aware that an inactive state exists for the UE and treats the UE as if it were in the connected state 706.

A UE transition from the inactive state 710 to the connected state 706 via a resume procedure as shown by arrow 714. A UE may initiate an RRC resume procedure to resume a previously suspended RRC connection. Specifically, the UE may resume SRB(s) or DRB(s) or perform an RNA update.

A UE may transition from the inactive state 710 to the idle state 702 if the radio link between the UE and the network fails.

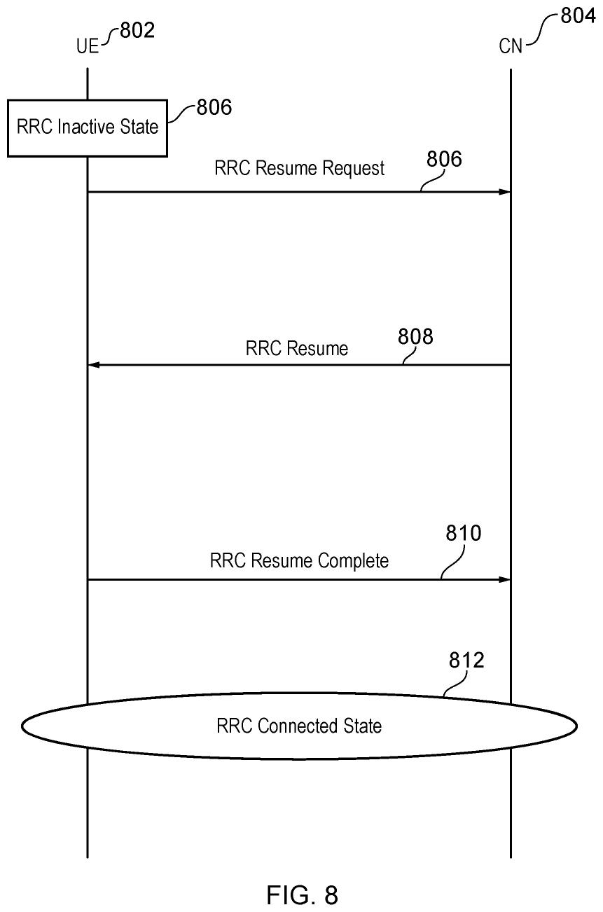

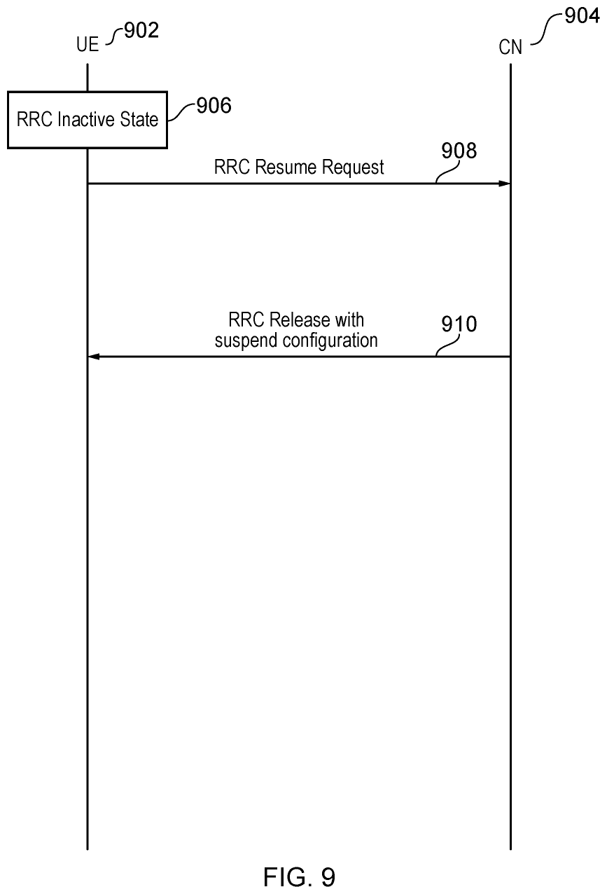

Examples of an RRC resume procedure are shown in FIGS. 8 and 9. In FIG. 8, a UE 802 in the inactive state 710 transmits a request to a core network 804 to resume its RRC connection in step 806. The core network 804 may determine to transition the UE 802 from the inactive state 710 to the connected state 706. Therefore, in step 808, the core network 804 sends an RRC resume message 808 to the UE 802, instructing the UE 802 to transition from the inactive state 710 to the connected state 706.

In FIG. 9, a UE 902 in the inactive state 710 transmits a request to a core network 904 to resume its RRC connection in step 906. In contrast to the scenario in FIG. 8, the core network 904 may determine to keep the UE 802 in the inactive state 710. Therefore, in step 908, the core network 904 sends an RRC release message including an indication to the UE 902 to suspend its configuration.

It is advantageous for a UE to remain in an inactive state where there is no immediate traffic between the UE and the core network but there is likely to be so in the near future. As the UE in the inactive state retains AS context as explained above, the transition from the inactive state to the connected state quicker than the transition from the idle state to the connected state.

As indicated above, as part of a process for establishing an RRC connection as well as for performing other functions Radio Network Temporary Identifiers (RNTI) of different types are used to identify a connected mode UE in the cell, or a specific radio channel. Types of RNTIs include:
P-RNTI: Paging RNTI. Used for Paging Message.
SI-RNTI: System Information RNTI. Used for transmission of SIB messages
RA-RNTI: Random Access RNTI. Used for PRACH Response.
C-RNTI: Cell RNTI. Used for the transmission to a specific UE after RACH.
T-CRNTI: Temporary C-RNTI. Mainly used during RACH
SPS-C-RNTI: Semi persistent Scheduling C-RNTI
TPC-PUCCH-RNTI: Transmit Power Control-Physical Uplink Control Channel-RNTI
TPC-PUSCH-RNTI: Transmit

As explained above, in certain scenarios, a UE may be performing radio communication with the core network via a trusted access point using an MA-PDU session. If the UE enters an inactive state, and establishes a service via an untrusted access point, a technical problem arises in ensuring that the MA-PDU session can be maintained to ensure service continuity as explained below

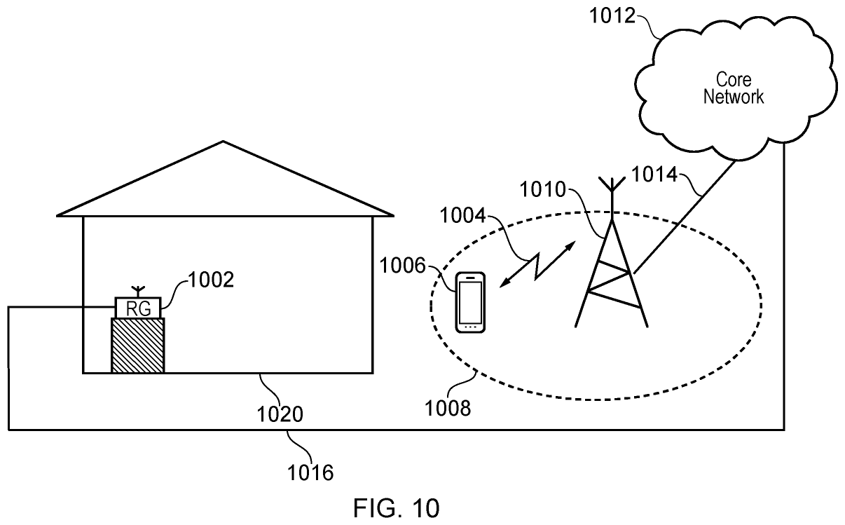

FIG. 10 illustrates a UE 1006 communicating over a radio link 1004 with a core network 1012 via a gNB 1010 in the coverage area 1008 of the gNB 1010. The gNB 1010 and residential gateway 1002 have wired connections 1014 and 1016 respectively to the core network. The gNB 1010 is an example of a “trusted access point”. The residential gateway 1002 is an example of an “untrusted access point”. For example, WiFi protocols may be implemented in the residential gateway 1002 or other wireless local area network (WLAN). As shown in FIG. 10, the untrusted access point 1002 may be deployed in a location (for example the private home of an individual) not owned by the operator of the gNB 1010. The untrusted access point 1002 is configured to provide access for UEs to the core network 1012 as shown by connection 1016.

In other examples, the residential gateway may be any hardware not under the control of the operator responsible the gNB 1010 which provides access for the UE 1006 to the core network 1012. In other examples, the residential gateway 1002 may be a private gNB connected to a private core network in an SNPN as explained with reference to FIG. 5a or FIG. 5b above.

At a later point, the gNB 1010 may instruct the UE 1006 to transition from a connected mode to an inactive mode as explained with respect to FIG. 7 above. However, in some examples the UE 1006 is instructed to transition from the connected mode to the inactive mode because there has not been traffic between the UE 1006 and the core network 1012 for a pre-defined time period for example. However, as explained above, the core network 1012 is not aware that the UE 1006 is in the inactive state. In this case, although the radio link between 1004 the UE 1006 and the gNB in the connected state is taken down for power conservation, the UE 1006 will retain AS context as explained above.

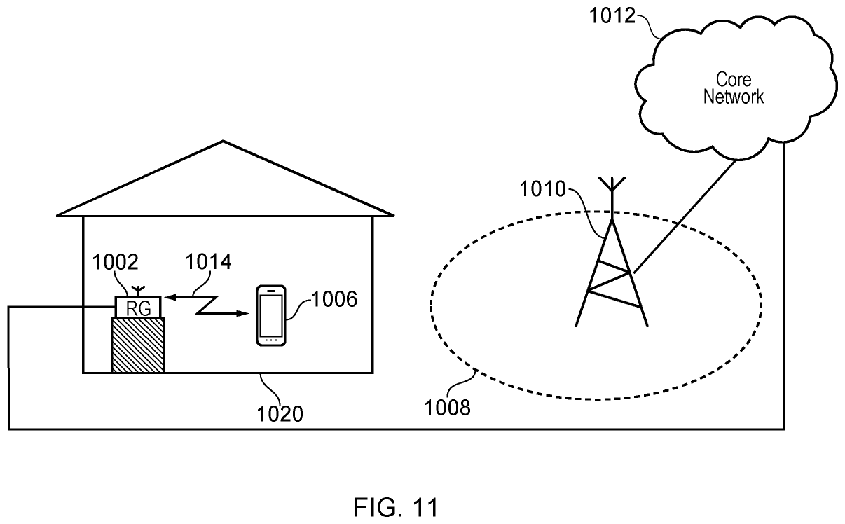

As shown in FIG. 11, a user of the UE 1006 may subsequently move within a coverage area of the untrusted access point 1002 whilst still being in the inactive state. In some examples (not shown in FIG. 11), the UE 1006 may be within both the coverage area of the untrusted access point 1002 and the coverage area 1008 of the trusted access point 1010 simultaneously. For example, although the coverage area 1008 of the trusted access point does not extend to include the untrusted access point 1002 and/or UE 1006 in FIG. 11, the UE 1006 and/or the untrusted access point 1002 may be within the coverage area 1008 of the trusted access point in some examples. Thereafter the user may use the UE 1002 to request a service or the request is based on a policy that for example, XR or gaming service will start indoor or when connected via a residential gateway. In one example, the request may be for a service provided over a MA-PDU session. In response to the user initiating the service, the UE 1006 forms a radio connection 1014 with the untrusted access point 1002. The UE 1006 may connect to the untrusted access point rather than the trusted access point because it is instructed to do so by ATSS rules for example as will be appreciated by one skilled in the art.

In response to the UE 1006 connecting to the untrusted access point 1002, the untrusted access point 1002 may transmit a notification to the core network 1012, informing the core network 1012 that the UE 1006 has requested a service.

In response to receiving the notification that the UE 1006 has requested the service, the core network 1012 may provide the requested service to the UE via the untrusted access point 1002.

The core network 1012 may or may not inform the gNB 1010 that the UE 1006 has requested a service. In some examples, the core network 1012 may decide not to inform gNB 1010 that the UE 1006 has requested a service because the service (based on ATSSS policy for example) can only be provided over the non-trusted network.

If the core network 1012 does not inform the gNB 1010 that the UE 1006 has requested the service, then the UE 1006 will remain in the inactive state. In such an example, the gNB 1010 will not be aware of information should as: the PDU session, QoS flow, UE context or the like associated with the service being provide to the UE 1006 via the untrusted access point 1002. Therefore, according to existing techniques, the gNB 1010 must establish a new session for the UE 1006 when the handover executed. This has the consequence that the time taken for the handover of the UE 1006 between the untrusted 1002 and trusted access point 1010 is prolonged because a new session must be established for the service. Additionally, because the gNB 1010 is not aware of the QoS of the service, the gNB 1010 may not have reserved an adequate amount of radio resources for the UE 1006. In one example, the QoS for the service is high (GBR service) and the gNB has not reserved enough radio resources to provide the service. In other example, the QoS for the service is low and the gNB 1010 has reserved too many resources, resulting in resource wastage.

In other examples, the core network 1012 may decide to inform the gNB 1010 that the UE 1006 has requested the new service if the new service is a Guaranteed Bit Rate (GBR) service. In such an example, the gNB 1010 may expect the UE 1006 to be handed over at a future point and the GBR service may have stringent packet loss requirements during the handover or require special resources to be reserved in the gNB 1010 after the handover has taken place. However, even if the core network 612 informs the gNB 1010 that the UE 1006 has requested the service, the gNB 1010 is not aware that the UE 1006 is receiving the service via the non-trusted access point 1002. Accordingly, the gNB may transmit a RAN paging message to the UE, prompting the UE 1006 to initiate a resume procedure as described in FIG. 8. As explained above, this may result in the UE 1006 transitioning to the connected state. As the UE 1006 is already receiving the service via the non-trusted access point 1002, transitioning the UE to the connected mode may result in power wastage. Additionally, as the UE 1006 is not receiving the service via the gNB 1010, the gNB 1010 may subsequently transition the UE 1006 back to the inactive state.

At a later point, the UE 1006 may move outside the coverage area of the untrusted access point 1022 (for example the user may move back outside with the UE 1006). Consequently, in order to ensure continuity of the service, the UE 1006 should be handed over from the untrusted access point 1002 to the gNB 1010. However, according to existing techniques, the UE 1006 will be in inactive state during the handover as explained above.

Broadly, embodiments of the present technique can provide a method performed by a communications device for providing service continuity in a handover of a communications device from an untrusted access point to a trusted access point in a wireless communications network. The method comprises transmitting, by transceiver circuitry of the communications device to the untrusted access point, a request to receive a service from a core network of the wireless communications network via the untrusted access point, the communications device being in an inactive state in which it retains a context from a previous communications session with the core network via the trusted access point; receiving, by the transceiver circuitry of the communications device from the untrusted access point, the requested service from the core network via the untrusted access point using a current communications session; determining, by the communications device, that a handover procedure should be performed for the communications device from the untrusted access point to the trusted access point; arranging, by the communications device, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point; receiving, by the transceiver circuitry of the communications device, the requested service from the core network via the trusted access point after the handover of the communications device from the untrusted access point to the trusted access point.

According to another aspect, disclosed embodiments of the present technique can provide a method performed by circuitry of a core network for providing service continuity in a handover of the communications device from an untrusted access point to a trusted access point in a wireless communications network. The method comprises receiving, by transceiver circuitry of the core network of the wireless communications network from the communications device via the untrusted access point, a request to receive a service from the core network via the untrusted access point, the communications device being in an inactive state in which it retains a context from a previous communications session with the core network via the trusted access point; providing by the transceiver circuitry of the core network to the communications device via the untrusted access point, the requested service using a current communications session; determining, by the core network, that a handover procedure should be performed for the communications device from the untrusted access point to the trusted access point; arranging, by the core network, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point; providing, by the transceiver circuitry of the core network, the requested service to the communications device via the trusted access point after the handover of the communications device from the untrusted access point to the trusted access point.

According to another aspect, disclosed embodiments of the present technique can provide a method performed by a trusted access point for providing service continuity in a handover of a communications device from an untrusted access point to the trusted access point in a wireless communications network. The method comprises determining, by the trusted access point, that a handover procedure should be performed for the communications device from the untrusted access point to the trusted access point; receiving, by transceiver circuitry of the trusted access point, information regarding a current communications session used for providing a requested service from the core network to the communications device via the untrusted access point in advance of a handover of the communications device between the untrusted and trusted access points, the information regarding the current communications session including at least an indication that the communications device is currently receiving the requested service via the untrusted access point; providing, by the transceiver circuitry of the trusted access point, the requested service from the core network via the trusted access point after the handover of the communications device from the untrusted access point to the trusted access point.

According to another aspect, disclosed embodiments of the present technique can provide a method performed by an untrusted access point for providing service continuity in a handover of a communications device from the untrusted access point to a trusted access point in a wireless communications network. The method comprises receiving, by transceiver circuitry of the untrusted access point from the communications device, a request to receive a service from a core network of the wireless communications network via the untrusted access point, the communications device being in an inactive state in which it retains a context from a previous communications session with the core network via the trusted access point; providing, by the transceiver circuitry of the untrusted access point to the communications device, the requested service from the core network via the untrusted access point using a current communications session; determining, by the untrusted access point, that a handover procedure should be performed for the communications device from the untrusted access point to the trusted access point; arranging, by the untrusted access point, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point.

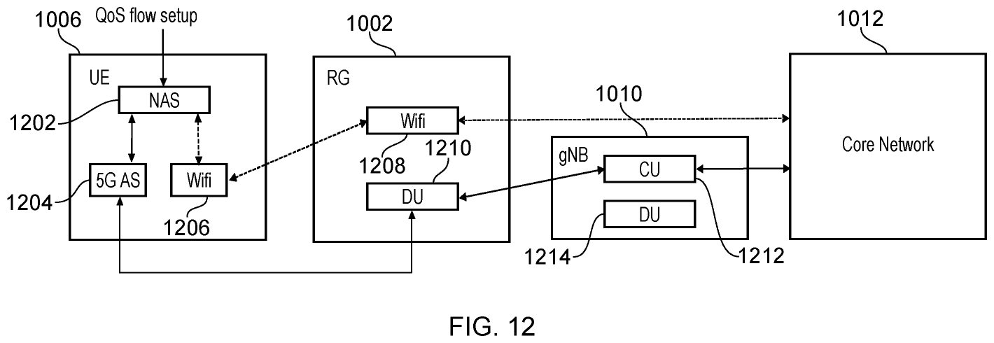

FIG. 12 schematically illustrates a simplification of the protocol stacks which may be present in the devices shown in FIGS. 10 and 11 according to some embodiments. As shown in FIG. 12, the UE 1006 may have a 5G access stratum (AS) layer and/or WiFi protocol stack 1206 which are connected to a common non-access stratum (NAS) layer 1202. In some embodiments, where the residential gateway 1002 has WiFi protocols implemented, the residential gateway 1002 has a peer WiFi protocol stack 1208 corresponding to the WiFi protocol stack 1206 in the UE 1006. In some embodiments, where the residential gateway 1002 forms part of an SNPN, the residential gateway 1002 has a distributed unit (DU) protocol stack 1210. The gNB has a peer DU protocol stack 1214 corresponding to the DU protocol stack 1210 in the residential gateway 1002. Protocol stacks in the core network 1012 are not shown for clarity. As indicated in FIG. 12, QoS flows for providing a service to the UE are set up in the NAS layer 1006 of the UE 1006 when the user requests a service. The dashed lines indicate routes for transmission of protocol data units between the UE 1006 and core network 1012 for untrusted access whereas the solid lines indicate routes for transmission protocol data units between the UE 1006 and core network 1012 for trusted access.

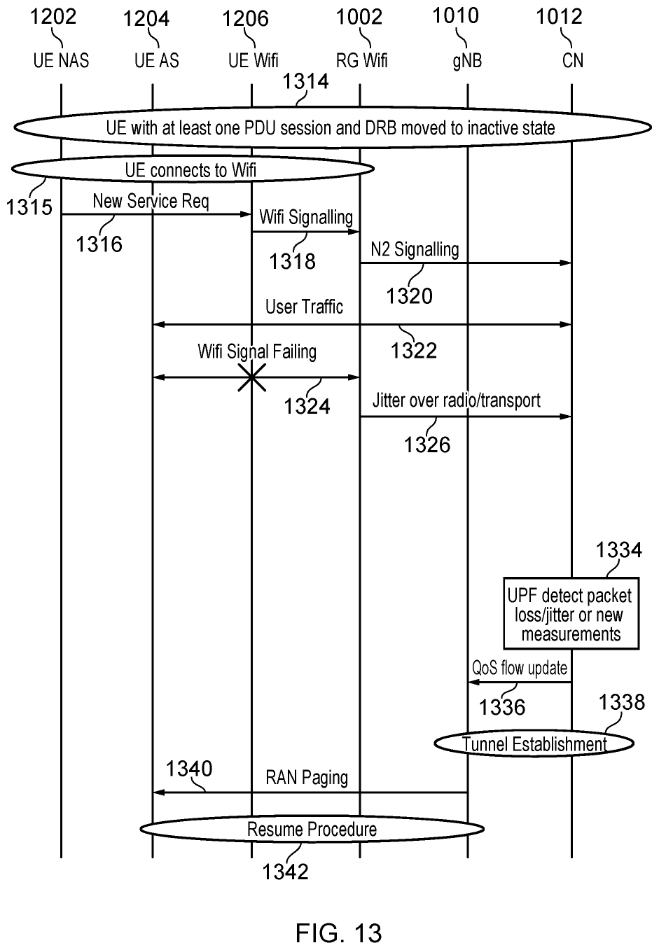

FIG. 13 illustrates a communication procedure for an embodiment in which the gNB 1010 is not aware that the UE 1006 has made new service request until the decision to handover the UE 1006 from the untrusted access point 1002 to the trusted access point 1010 has been made has been made.

Initially the UE 1006 may be communicating with a core network 1012 with at least one PDU session and DRB via a trusted access point such as gNB 1010 similar to the situation in FIG. 10. Subsequently, in step 1314, the UE 1006 may be transitioned to an inactive state if the gNB 1010 sends an RRC release message to the UE 1006 including an indication that the UE 1006 should suspend configuration. As explained above, the UE 1006 retains AS context whilst in the inactive state as explained above.

Thereafter, the UE 1006 may enter the coverage area of a non-trusted access point. For example, the UE 1006 may be brought within the coverage point of the residential gateway 1002 with WiFi implemented. In step 1315, the UE 1006 establishes a connection with the residential gateway 1002. The UE 1006 may connect with the residential gateway 1002 rather than the gNB 1010 because of ATSSS policies for example.

Subsequently, a user of the UE 1006 may request a service (for example a GBR service) from the core network 1012. Therefore, in step 1316, the NAS layer of the UE 1202 may submit the request for the service to the WiFi protocol stack 1206 in the UE 1006. The WiFi protocol stack 1206 in the UE 1006 forwards the request to the residential gateway 1002 in step 1318. In step 1320, an N2 interface is used to transmit the request on the control plane between the residential gateway 1002 and the core network 1012. In step 1322, the UE 1006 is receiving the service from the core network 1012.

However, at a future point, the WiFi signal may begin to fail. In one example, as WiFi is a short range technology, the WiFi signal may fail if the UE 1006 becomes more than a pre-determined distance away from the residential gateway 1002. For example, the user of the UE 1006 may move outside the house in which the residential gateway 1002 is located.

In accordance with an exemplary embodiment, as shown in FIG. 13, in response to detecting that the WiFi signal is failing, the residential gateway 1002 transmits measurements of the radio conditions between the residential gateway 1002 and the UE 1006 to a UPF of the core network 1012 as shown in step 1326. Such measurements may include jitter and/or packet loss measurements. Jitter measurements are related to variation in a delay of received packets as will be appreciated by one skilled in the art. In some examples, jitter measurements may account for processing delays in a node (for example processing within core network entities such as AMF, Session Management Function (SMF) and/or UPF) and a transmission delay due to scheduling decisions or retransmissions. For wireless interfaces, the variation in transmission delay may be introduced by Hybrid Automatic Repeat Request (HARQ) retransmissions over the radio if the UE is in poor radio conditions for example. For wired interfaces, the variation in transmission delay may be due to congestion in the network.

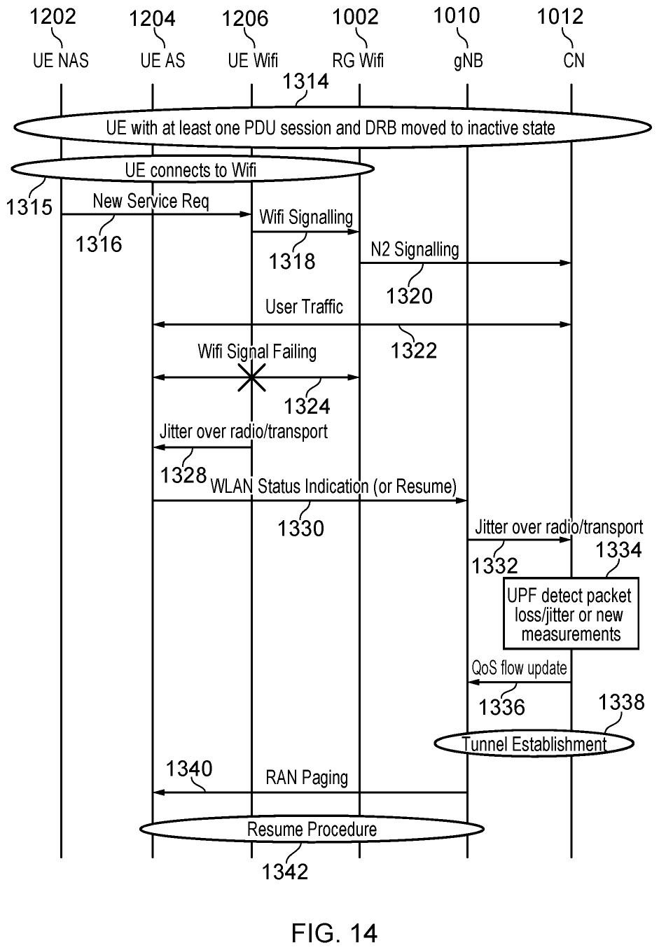

Alternatively, the measurements of the radio conditions may be made by the UE 1006. In this embodiment, as shown in FIG. 14, the WiFi protocol stack 1206 of the UE 1006 provides the measurements to the UE AS layer 1202 in step 1328. The UE AS layer 1202 may then forward the measurements to the gNB 1010 in a WLAN status indication (or as part of a resume request) in step 1330. The gNB 1010 may then forward the measurements onto the UPF of the core network 1012.

In either embodiment represented by FIG. 13 or 14, the UPF of the core network 1012 detects the measurements of the radio conditions in step 1334. In response to detecting the measurements of the radio conditions, the UPF initiates switching from untrusted AS to trusted AS of the PDU session/QoS flow as shown in steps 1336 and 1338 and also establish the new service/PDU session/QoS flow towards the gNB.

As the gNB 1010 has now become aware that the UE 1006 has requested a service, it may transmit a RAN paging message in step 1340 prompting the UE 1006 to initiate an RRC resume procedure 1342 (such as that shown in FIG. 8 or 9).

In some embodiments, the untrusted access point 1002 may be an SNPN. In this embodiment, a gNB of the SNPN (such as gNB 510) may transmit an indication to the UPF informing the UPF about a split of jitter measurements between radio and transport. In such embodiments, the UE's AMF/SMF may control the gNB 510 which keeps the UE context. The AMF may then signal to the gNB for a new service/QoS flow to be added and thereby establish a new tunnel between the UPF and gNB.

In some embodiments, the UE 1006 may determine on the basis of the measured radio conditions made by the UE 1006 that the UE 1006 should be handed over from the untrusted access point 1002 to the trusted access point 1010. In such embodiments, after a user plane path is established to the UPF of the core network 1012, the UE AS 1204 may inform the gNB 1010 via an RRC Resume procedure that the UE 1006 should be handed over from the untrusted access point 1002 to the trusted access point 1010. The AMF, SMF and/or UPF will then establish a bearer/QoS flow towards the gNB 1010. For example, with reference to FIG. 14, the UE 1006 may, after in step 1328, determine on the basis of the measured radio conditions that the UE 1006 should be handed over from the untrusted access point 1002 to the trusted access point 1010. Steps 1330 to 1338 are optional in this embodiment. In other words, the UE 1006 may not inform the UPF of the measured quality of the radio conditions in this embodiment. Subsequently, the UE 1006 may transmit an indication to the gNB 1010 as part of a resume procedure (such as resume procedure 1342) that the UE 1006 should be handed over from the untrusted access point 1002 to the trusted access point 1010.

In exemplary embodiments, such as those described with reference to FIGS. 13 and 14, the provision of measurements of the quality of the radio conditions between the UE 1006 and the untrusted access point 1002 to core network 1012, enable the core network 1012 to determine an optimum time at which to perform a QoS flow update with the gNB 1010 to ensure service continuity of service when the UE 1006 is handed over from the untrusted access point 1002 to the trusted access point 1010. In such embodiments, in order to separate different causes of delay, delay measurements are split over radio and transport network as described above. Therefore, the UPF can be made aware whether jitter build up is due to poor radio conditions or transport congestion. If the jitter build up is due to poor radio conditions, the UPF may device to switch to another node. By contrast, if the jitter build up is due to transport congestion then a switch may not be required because transport congestion may be similar on different routes. Such embodiments improve UPF knowledge about jitter breakdown so that UPF may determine an optimum time at which the service should be switched from being provided to the UE 1006 via the untrusted access point 1002 to being provided by the UE 1006 to the trusted access point 1010.

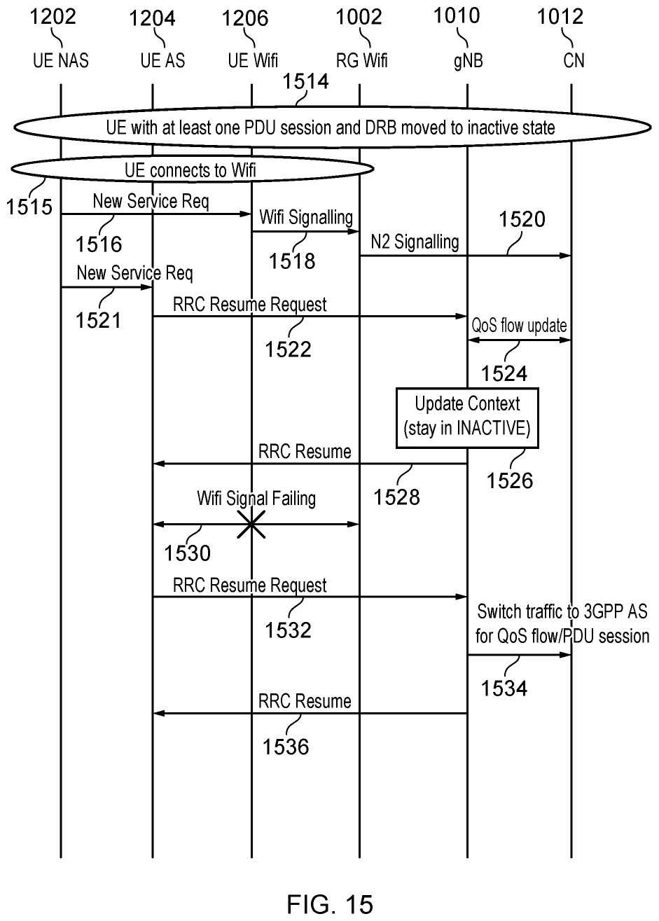

FIG. 15 illustrates a communication procedure for an embodiment in which the gNB 1010 is made aware that the UE 1006 has made new service request before a handover decision is made. In some embodiments, the UE NAS may trigger QoS flow setup for the AS layers 1204, 1210 and WiFi protocol stacks 1206, 1208 in both the UE 1006 and the residential gateway 1002.

Initially the UE 1006 may be communicating with a core network 1012 with at least one PDU session and DRB via a trusted access point such as gNB 1010 similar to the situation in FIG. 10. Subsequently, in step 1514, the UE 1006 may be transitioned to an inactive state if the gNB 1010 sends an RRC release message to the UE 1006 including an indication that the UE 1006 should suspend configuration. The UE 1006 retains AS context whilst in the inactive state as explained above.

Thereafter, the UE 1006 may enter the coverage area of a non-trusted access point. For example, the UE 1006 may be brought within the coverage point of the residential gateway 1002 with WiFi implemented. In step 1515, the UE 1006 establishes a connection with the residential gateway 1002. The UE 1006 may connect with the residential gateway 1002 rather than the gNB 1010 because of ATSSS policies for example.

Subsequently, a user of the UE 1006 may request a service (for example a GBR service) from the core network 1012. Therefore, in step 1516, the NAS layer of the UE 1202 may submit the request for the service to the WiFi protocol stack 1206 in the UE 1006. The WiFi protocol stack 1206 in the UE 1006 forwards the request to the residential gateway 1002 in step 1518. In step 1520, an N2 interface is used to transmit the request on the control plane between the residential gateway 1002 and the core network 1012.

In step 1521, the NAS layer 1202 of the UE 1006 notifies the AS layer 1204 in the UE 1006 that the UE 1006 has made a request for a service. In response, the AS layer 1204 of the UE 1006 submits an RRC resume request (which may broadly correspond to resume requests 806 and 906 in FIGS. 8 and 9 respectively) to the gNB 1010 in step 1522. However, in contrast to RRC Resume Request messages 806, 906 of the art, the UE 1006 may include a new cause value in the resume request 1522 to notify the gNB 1010 that the UE 1006 prefer to receive the service via the untrusted access and UE may be kept in inactive state at the end of this procedure. The resume request 1522 may also include an indication that the service is being provided to the UE 1006 via a MA-PDU session. Therefore, the RRC Resume Request 1522 is used to make the gNB 1010 aware that the UE 1006 is receiving a service via an untrusted access point 1002. This prevents the UE 1006 from unnecessarily entering the connected state until the WiFi signal fails 1530 and the UE 1006 is handed over to the gNB 1010.

In response to receiving the resume request 1522, the gNB performs a QoS flow update 1524 with the core network 1010 (which may broadly correspond to the QoS flow update 1336 described above). The gNB 1010 may then update the UE context in step 1526 followed by transmitting an RRC resume message 1528 to the UE 1006 including an indication instructing the UE 1006 to remain in the inactive state. Transmitting an indication instructing the UE 1006 to remain in the inactive state ensures that the UE 1006 does not apply a default cell configuration and allows the gNB to update the UE context with a new bearer. In some embodiments the gNB may transition the UE to the connected state as part of the resume procedure. In such embodiments, the UE may transmit the WLAN connection status report in the connected mode informing the gNB that that the UE is receiving the service via an untrusted access point.

Subsequently, the UE 1006 may detect that it has lost or about to lose connectivity with the untrusted access point. For example, the UE 1006 may measure a quality of radio conditions between the UE 1006 and the untrusted access point, and determine that the quality of the radio conditions is below a pre-defined threshold. In some embodiments, the UE 1006 may measure a signal to noise plus interference (SINR) ratio, reference signal received power (RSRP), reference signal received quality (RSRQ) or block error rate (BLER) for example. The UE 1006 may determine that the quality of the radio conditions is below a pre-defined threshold if the measured SINR, RSRP, RSRQ or BLER is below a pre-defined threshold. In response, the UE 1006 may send a second RRC Request message 1532 including an indication that the UE 1006 should switch from receiving the service via the non-trusted network 1002 to receiving the service via the gNB 1010. The indication may be included as a cause value in the RRC Request message 1532.

In response to receiving the second RRC Resume Request 1532, the gNB 1010 may send an indication 1534 to the UPF to provide the service via the gNB 1010. The gNB 1010 then sends a second RRC resume message 1536 to the UE 1006 instructing the UE 1006 to transition to the connected state. Thereafter, the service is provided from the core network to the UE 1006 via the gNB 1010.

In exemplary embodiments, such as those described with reference to FIG. 15, the RRC Resume Request 1520 may be used to make the gNB 1010 aware that the UE 1006 is receiving a service via an untrusted access point. This prevents the UE 1006 from unnecessarily entering the connected state until the WiFi signal fails 1530 and the UE 1006 is handed over to the gNB 1010. In addition, the RRC resume request may cause the gNB 1010 to update the UE 1006 context, meaning that the switching of the traffic from the untrusted access point to the trusted access point occurs much quicker during the handover, thereby ensuring service continuity.

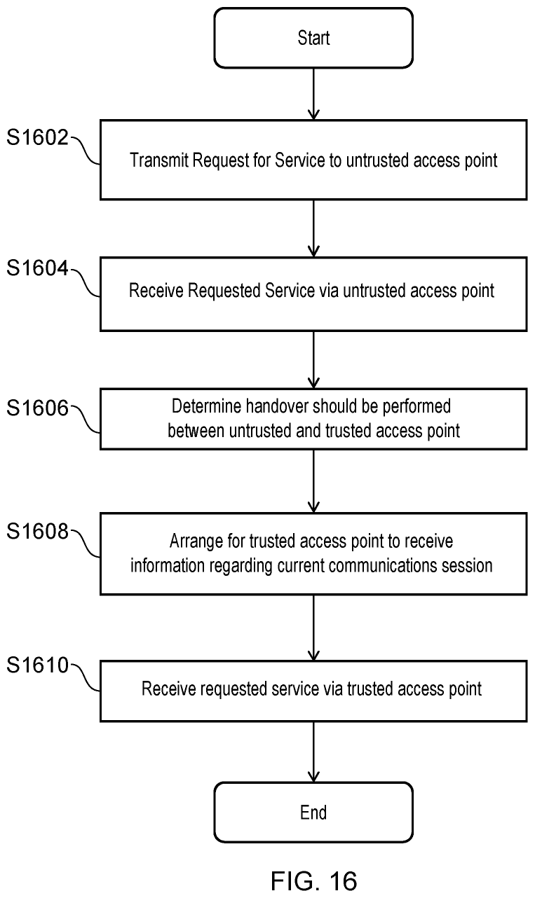

FIG. 16 is a flow diagram illustrating steps performed by a communications device according to example embodiments of a method for providing service continuity in a handover of the communications device from an untrusted access point to a trusted access point in a wireless communications network. As explained above, a “trusted access point” may be an infrastructure equipment providing access to a core network. The infrastructure may be trusted from the perspective of an operator who controls, owns or is otherwise responsible for the infrastructure equipment. For example, the operator may be responsible for deploying the infrastructure equipment. However, if the infrastructure equipment is deployed in a location not controlled or owned by the operator (for example, if the infrastructure equipment is a residential gateway implementing WiFi protocols in the home of a private individual or an SNPN in a factory not owned by the operator for example), or is deployed by a different operator, then the infrastructure equipment may be regarded as an “untrusted access point” to the core network from the perspective of the operator.

After a start point, the communications device transmits a request to receive a service from a core network of the wireless communications network via the untrusted access point to the untrusted access point in step S1602. The communications device is in an inactive state in which it retains a context from a previous communications session with the core network via the trusted access point. The context retained by the communications device may be an AS context as explained above.

In step S1604, the communications device receives the requested service from the core network via the untrusted access point using a current communications session. The requested service may be a GBR service for example.

In step S1606, the communications device determines that a handover procedure should be performed for the communications device from the untrusted access point to the trusted access point.

In step S1608, the communications device, arranges for the trusted access point to receive information regarding the current communications session used for providing the requested service from the core network to the communications device via the untrusted access point in advance of the handover. The information regarding the current communications session includes at least an indication that the communications device is currently receiving the requested service via the untrusted access point.

In step S1610, the communications device receives the requested service from the core network via the trusted access point after the handover of the communications device from the untrusted access point to the trusted access point. In some examples, the trusted access point may transition the communications device to a connected mode before the communications device receives the requested service from the core network via the trusted access point after the handover. After step S1610, the procedure ends.

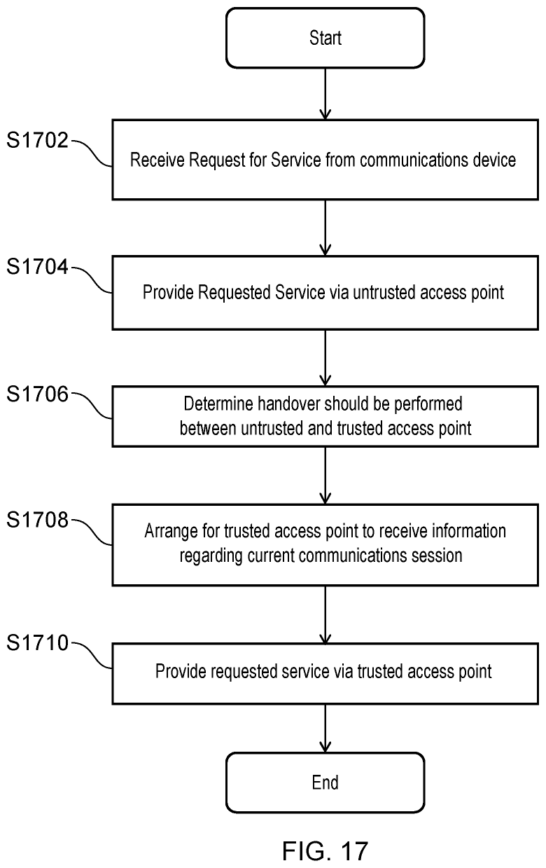

FIG. 17 is a flow diagram illustrating steps performed by circuitry in a core network according to example embodiments of a method for providing service continuity in a handover of a communications device from an untrusted access point to a trusted access point in a wireless communications network.

After a start point, transceiver circuitry of the core network of the wireless communications network receives, from the communications device via the untrusted access point, a request to receive a service from the core network via the untrusted access point in step S1702. The communications device is in an inactive state in which it retains a context from a previous communications session with the core network via the trusted access point.

In step S1704, the transceiver circuitry of the core network provides, to the communications device via the untrusted access point, the requested service using a current communications session.

In step S1706, the core network determines that a handover procedure should be performed for the communications device from the untrusted access point to the trusted access point.

In step S1708, the core network arranges for the trusted access point to receive information regarding the current communications session used for providing the requested service from the core network to the communications device via the untrusted access point in advance of the handover. The information regarding the current communications session includes at least an indication that the communications device is currently receiving the requested service via the untrusted access point.

In step S1710, the transceiver circuitry of the core network provides the requested service to the communications device via the trusted access point after the handover of the communications device from the untrusted access point to the trusted access point. After step S1710, the procedure ends.

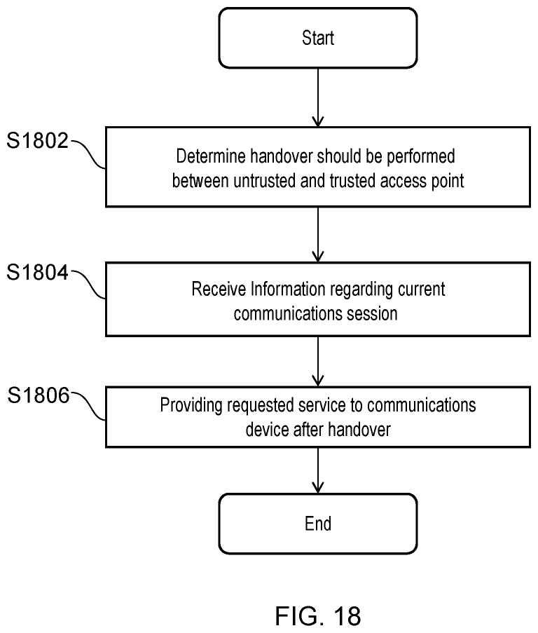

FIG. 18 is a flow diagram illustrating steps performed by a trusted access point according to example embodiments of a method for providing service continuity in a handover of a communications device from an untrusted access point to the trusted access point in a wireless communications network.

After a start point, the trusted access point determines that a handover procedure should be performed for the communications device from the untrusted access point to the trusted access point in step S1802.

In step S1804, transceiver circuitry of the trusted access point receives information regarding a current communications session used for providing a requested service from the core network to the communications device via the untrusted access point in advance of a handover of the communications device between the untrusted and trusted access points. The information regarding the current communications session includes at least an indication that the communications device is currently receiving the requested service via the untrusted access point.

In step 1806, the transceiver circuitry of the trusted access point provides the requested service from the core network via the trusted access point after the handover of the communications device from the untrusted access point to the trusted access point. After step S1806, the procedure ends.

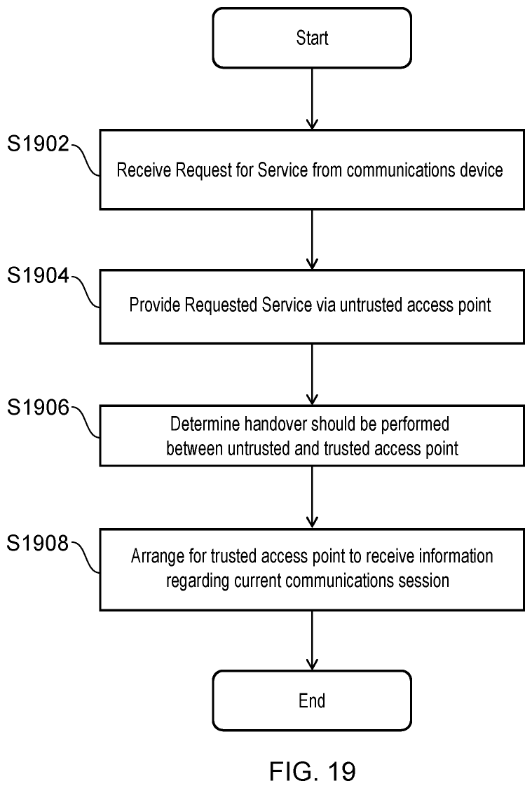

FIG. 19 is a flow diagram illustrating steps performed by an untrusted access point according to example embodiments of a method for providing service continuity in a handover of a communications device from the untrusted access point to a trusted access point in a wireless communications network After a start point, transceiver circuitry of the untrusted access point receives, from the communications device, a request to receive a service from a core network of the wireless communications network via the untrusted access point in step S1902. The communications device is in an inactive state in which it retains a context from a previous communications session with the core network via the trusted access point.

In step S1904, the transceiver circuitry of the untrusted access point provides, to the communications device, the requested service from the core network via the untrusted access point using a current communications session.

In step S1906, the untrusted access point determines that a handover procedure should be performed for the communications device from the untrusted access point to the trusted access point.

In step S1908, the untrusted access point arranges for the trusted access point to receive information regarding the current communications session used for providing the requested service from the core network to the communications device via the untrusted access point in advance of the handover. The information regarding the current communications session includes at least an indication that the communications device is currently receiving the requested service via the untrusted access point. After step S908, the procedure ends.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method for providing service continuity in a handover of a communications device from an untrusted access point to a trusted access point in a wireless communications network, the method comprising:
transmitting, by transceiver circuitry of the communications device to the untrusted access point, a request to receive a service from a core network of the wireless communications network via the untrusted access point, the communications device being in an inactive state in which it retains a context from a previous communications session with the core network via the trusted access point;
receiving, by the transceiver circuitry of the communications device from the untrusted access point, the requested service from the core network via the untrusted access point using a current communications session;
determining, by the communications device, that a handover procedure should be performed for the communications device from the untrusted access point to the trusted access point; arranging, by the communications device, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
receiving, by the transceiver circuitry of the communications device, the requested service from the core network via the trusted access point after the handover of the communications device from the untrusted access point to the trusted access point.

Paragraph 2. A method according to paragraph 1, wherein the arranging, by the communications device, for the trusted access point to receive information regarding the current communications session used for providing the requested service from the core network to the communications device via the untrusted access point in advance of the handover, comprises
measuring, by control circuitry in the communications device, a quality of radio and transport conditions between the communications device and the untrusted access point when the communications device is receiving the requested service from the untrusted access point;
transmitting, by the transceiver circuitry in the communications device to the core network, an indication of the measured quality of the radio and transport conditions and, in response to receiving the measurements, the core network performs a Quality of Service (QoS) set-up procedure with the trusted access point in which the trusted access point receives the indication that the communications device is currently receiving the requested service from the core network via the untrusted access point.

Paragraph 3. A method according to paragraph 2 or 3, wherein the transmitting, by the transceiver circuitry in the communications device, the indication of the measured quality of the radio and transport conditions to the trusted access point comprises,
including, by control circuitry in the communications device, the indication of the measured quality of the radio and transport conditions in a Wireless Local Area Network (WLAN) Status indication message;
transmitting, by the transceiver circuitry in the communications device, the WLAN to the trusted access point for forwarding onto the core network.

Paragraph 4. A method according to paragraph 2 or 3, wherein the transmitting, by the transceiver circuitry in the communications device, the indication of the measured quality of the radio and transport conditions to the trusted access point comprises,
including, by control circuitry in the communications device, the indication of the measured quality of the radio and transport conditions in an RRC Resume message;
transmitting, by the transceiver circuitry in the communications device, the RRC Resume message to the trusted access point for forwarding onto the core network.

Paragraph 5. A method according to any of paragraphs 1 to 4, wherein the measuring, by the control circuitry in the communications device, the quality of radio and transport conditions between the communications device and the untrusted access point when the communications device is receiving the requested service from the untrusted access point comprises
measuring jitter and packet loss between the communications device and the untrusted access point when the communications device is receiving the requested service from the untrusted access point; and
the transmitting, by the transceiver circuitry in the communications device to the core network, the indication of the measured quality of the radio and transport conditions comprises
transmitting an indication of the measured jitter and packet loss.

Paragraph 6. A method according to paragraph 1, wherein the transmitting, by the transceiver circuitry of the communications device to the untrusted access point, the request to receive the service from the core network of the wireless communications network via the untrusted access point comprises
submitting, by a non-access stratum (NAS) protocol layer in the communications device, the request for receiving the service to an access (AS) protocol layer in the communications device and the transceiver circuitry of the communications device transmitting the request to receive the service in response.

Paragraph 7. A method according to paragraph 1 or 6, wherein the arranging, by the communications device, for the trusted access point to receive information regarding the current communications session used for providing the requested service from the core network to the communications device via the untrusted access point in advance of the handover, comprises
transmitting, by the transceiver circuitry in the communications device to the trusted access point, a request that the communications device remains in the inactive state including the indication that the communications device is currently receiving the request service from the core network via the untrusted access point;
receiving, by the transceiver circuitry in the communications device from the trusted access point, an instruction to remain in the inactive state.

Paragraph 8. A method according to paragraph 7, wherein the transmitting, by the transceiver circuitry in the communications device to the trusted access point, the request that the communications device remains in the inactive state comprises
including, by control circuitry in the communications device, a cause value in an RRC Resume Request message indicating that the communications device wishes to remain in the inactive state;
transmitting, by transceiver circuitry in the communications device to the trusted access point, the RRC Resume Request message; and the receiving, by the transceiver circuitry in the communications device from the trusted access point, the instruction to remain in the inactive state comprises
receiving, by the transceiver circuitry in the communications device from the trusted access point, an RRC Resume message including an instruction to remain in the inactive state.

Paragraph 9. A method according to any of paragraphs 1 to 8, comprising
measuring, by the control circuitry in the communications device, a quality of radio conditions between the communications device and the untrusted access point when the communications device is receiving the requested service from the untrusted access point; and wherein the determining, by the communications device, that the handover procedure should be performed for the communications device from the untrusted access point to the trusted access point comprises:
detecting, by the control circuitry in the communications device, based on the measurements of the quality of the radio conditions, that the quality of the radio conditions are below a pre-defined threshold and, in response,
transmitting, by the transceiver circuitry in the communications device, an indication to the trusted access point that the communications device should be handed over from the untrusted access point to the trusted access point.

Paragraph 10. A method according to paragraph 9, wherein the transmitting, by the transceiver circuitry in the communications device, the indication to the trusted access point that the communications device should be handed over from the untrusted access point to the trusted access point comprises
including, by the control circuitry in the communications device, a cause value in a second RRC Resume Request message indicating that the communications device should handover from the untrusted access point to the trusted access point;
transmitting, by the transceiver circuitry in the communications device, the second RRC Request message to the trusted access point.

Paragraph 11. A method according to paragraph 9 or 10, wherein the measuring, by the control circuitry in the communications device, the quality of the radio conditions between the communications device and the untrusted access point when the communications device is receiving the requested service from the untrusted access point comprises
measuring one or more of a signal to noise plus interference (SINR) ratio, reference signal received power (RSRP), reference signal received quality (RSRQ) or block error rate (BLER) and the detecting, by the control circuitry in the communications device, based on the measurements of the quality of the radio conditions, that the quality of the radio conditions are below a pre-defined threshold comprises detecting that the measured one or more of the measured SINR, RSRP, RSRQ or BLER is below a pre-defined threshold.

Paragraph 12. A method according to any of paragraphs 1 to 11, wherein the determining, by the communications device, that the handover procedure should be performed for the communications device from the untrusted access point to the trusted access point comprises
receiving an indication from the core network via the trusted access point that the handover procedure should be performed for the communications device from the untrusted access point to the trusted access point.

Paragraph 13. A method according to any of paragraphs 1 to 12, wherein the non-trusted access point is a base station forming part of a stand-alone non-public network (SNPN).

Paragraph 14. A method according to any of paragraphs 1 to 13, wherein the non-trusted access point is a residential gateway implementing WiFi protocols for radio communication.

Paragraph 15. A method according to any of paragraphs 1 to 14, wherein the trusted access point is infrastructure equipment forming part of the wireless communications network.

Paragraph 16. A method according to any of paragraphs 1 to 15, wherein the current communications session is a Multi-Access Protocol Data Unit (MA-PDU) session.

Paragraph 17. A method according to any of paragraphs 1 to 16, wherein the requested service is a Guaranteed Bit Rate (GBR) service.

Paragraph 18. A method for providing service continuity in a handover of a communications device from an untrusted access point to a trusted access point in a wireless communications network, the method comprising:
receiving, by transceiver circuitry of a core network of the wireless communications network from the communications device via the untrusted access point, a request to receive a service from the core network via the untrusted access point, the communications device being in an inactive state in which it retains a context from a previous communications session with the core network via the trusted access point;
providing by the transceiver circuitry of the core network to the communications device via the untrusted access point, the requested service using a current communications session;
determining, by the core network, that a handover procedure should be performed for the communications device from the untrusted access point to the trusted access point;
arranging, by the core network, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
providing, by the transceiver circuitry of the core network, the requested service to the communications device via the trusted access point after the handover of the communications device from the untrusted access point to the trusted access point.

Paragraph 19. A method according to paragraph 18, wherein the determining, by the core network, that a handover procedure should be performed for the communications device from the untrusted access point to the trusted access point comprises
receiving, by the transceiver circuitry in the core network, a measured quality of radio and transport conditions between the communications device and the untrusted access point when the communications device is receiving the requested service from the untrusted access point;
determining based on the received measurements of the quality of the radio and transport conditions that the handover procedure should be performed for the communications device from the untrusted access point to the trusted access point; and the arranging, by the core network, for the trusted access point to receive information regarding the current communications session used for providing the requested service from the core network to the communications device via the untrusted access point in advance of the handover comprises
performing a Quality of Service (QoS) set-up procedure with the trusted access point in which the trusted access point receives the indication that the communications device is currently receiving the requested service from the core network via the untrusted access point.

Paragraph 20. A method according to paragraph 19, wherein the receiving, by the transceiver circuitry in the core network, the measured quality of radio and transport conditions between the communications device and the untrusted access point when the communications device is receiving the requested service from the untrusted access point comprises receiving the measured quality of the radio and transport conditions from either the untrusted access point or from the communications device via the trusted access point.
receiving a measured quality of radio and transport conditions between the communications device and the untrusted access point when the communications device is receiving the requested service from the untrusted access point

Paragraph 21. A method according to paragraph 19 or 20, wherein the measured quality of the radio and transport conditions are measurements of jitter and packet loss between the communications device and the untrusted access point when the communications device is receiving the requested service from the untrusted access point.

Paragraph 22. A method according to paragraph 18, wherein the arranging, by the core network, for the trusted access point to receive information regarding the current communications session used for providing the requested service from the core network to the communications device via the untrusted access point in advance of the handover, comprises
receiving, by the transceiver circuitry in the core network, an indication that the trusted access point has received a request from the communications device that the communications device remains in the inactive state including the indication that the communications device is currently receiving the request service from the core network via the untrusted access point; and in response performing a Quality of Service (QoS) set-up procedure with the trusted access point.

Paragraph 23. A method according to paragraph 18, wherein the determining, by the core network, that the handover procedure should be performed for the communications device from the untrusted access point to the trusted access point comprises
receiving, by the transceiver circuitry in the core network from the trusted access point, an indication that the trusted access point received a request from the communications device that the communications device should handover from the untrusted access point to the trusted access point; determining that the handover procedure should be performed for the communications device from the untrusted access point to the trusted access point.

Paragraph 24. A method for providing service continuity in a handover of a communications device from an untrusted access point to a trusted access point in a wireless communications network, the method comprising:
determining, by the trusted access point, that a handover procedure should be performed for the communications device from the untrusted access point to the trusted access point;
   receiving, by transceiver circuitry of the trusted access point, information regarding a current communications session used for providing a requested service from the core network to the communications device via the untrusted access point in advance of a handover of the communications device between the untrusted and trusted access points, the information regarding the current communications session including at least an indication that the communications device is currently receiving the requested service via the untrusted access point;
providing, by the transceiver circuitry of the trusted access point, the requested service from the core network via the trusted access point after the handover of the communications device from the untrusted access point to the trusted access point.

Paragraph 25. A method according to paragraph 24, comprising
receiving, by the transceiver circuitry in the trusted access point from the communications device, an indication of a measured quality of the radio and transport conditions between the communications device and the untrusted access point when the communications device is receiving the requested service from the untrusted access point; and
transmitting, by the transceiver circuitry in the trusted access point, to the core network, an indication of the measured quality of the radio and transport conditions between the communications device and the untrusted access point when the communications device is receiving the requested service from the untrusted access point.

Paragraph 26. A method according to paragraph 24, wherein the receiving, by the transceiver circuitry in the trusted access point from the communications device, the indication of a measured quality of the radio and transport conditions between the communications device and the untrusted access point when the communications device is receiving the requested service from the untrusted access point comprises
receiving the indication of the measured quality of the radio conditions in a Wireless Local Area Network (WLAN) Status indication message.

Paragraph 27. A method according to paragraph 2, wherein the receiving, by the transceiver circuitry in the trusted access point from the communications device, the indication of a measured quality of the radio and transport conditions between the communications device and the untrusted access point when the communications device is receiving the requested service from the untrusted access point comprises
receiving the indication of the measured quality of the radio and transport conditions in an RRC Resume message.

Paragraph 28. A method according to paragraph 24, wherein the receiving, by the transceiver circuitry of the trusted access point, the information regarding a current communications session used for providing a requested service from the core network to the communications device via the untrusted access point in advance of the handover of the communications device between the untrusted and trusted access points comprises
performing a Quality of Service (QoS) set-up procedure with the core network in which the trusted access point receives the indication that the communications device is currently receiving the requested service from the core network via the untrusted access point; and, in response,
transmitting, by the transceiver circuitry in the trusted access point to the communications device, an indication that the communications device should perform a resume procedure with the trusted access point.

Paragraph 29. A method according to paragraph 28, wherein the transmitting, by the transceiver circuitry in the trusted access point to the communications device, an indication that the communications device should perform a resume procedure with the trusted access point comprises
transmitting a Radio Access Network (RAN) paging message to the communications device.

Paragraph 30. A method according to paragraph 28, wherein the receiving, by transceiver circuitry of the trusted access point, the information regarding a current communications session used for providing a requested service from the core network to the communications device via the untrusted access point in advance of a handover of the communications device between the untrusted and trusted access point comprises
receiving, by the transceiver circuitry in the trusted access point from the communications device, a request that the communications device remains in the inactive state including the indication that the communications device is currently receiving the request service from the core network via the untrusted access point;
performing a Quality of Service (QoS) flow update procedure with the core network; and transmitting, by the transceiver circuitry in the trusted access point to the communications device, an instruction to remain in the inactive state.

Paragraph 31. A method according to paragraph 30, wherein the receiving, by the transceiver circuitry in the trusted access point from the communications device, the request that the communications device remains in the inactive state including the indication that the communications device is currently receiving the request service from the core network via the untrusted access point comprises receiving the request that the communications device remains in the inactive state in an RRC Resume Request Message and
the transmitting, by the transceiver circuitry in the trusted access point to the communications device, an instruction to remain in the inactive state comprises
including, by control circuitry in the trusted access point, the instruction to remain in an inactive state in an RRC resume message and
transmitting, by the transceiver circuitry in the trusted access point, the RRC Resume Message to the communications device.

Paragraph 32. A method according to paragraph 30 or 31, wherein the determining, by the trusted access point, that the handover procedure should be performed for the communications device from the untrusted access point to the trusted access point
receiving, by the transceiver circuitry of the trusted access point from the communications device, an indication that the communications device should be handed over from the untrusted access point to the trusted access point.

Paragraph 33. A method according to paragraph 31, wherein the receiving, by the transceiver circuitry of the trusted access point from the communications device, an indication that the communications device should be handed over from the untrusted access point to the trusted access point comprises
receiving the indication that the communications device should be handed over from the untrusted access point to the trusted access point in a second RRC Request Message.

Paragraph 34. A method according to paragraph 32 or 33, wherein, in response to the receiving, by the transceiver circuitry of the trusted access point from the communications device, an indication that the communications device should be handed over from the untrusted access point to the trusted access point, the transceiver circuitry of the trusted access point transmits an instruction to the communications device to hand over from the untrusted access point to the trusted access point.

Paragraph 35. A method according to claim 34, wherein the instruction to the communications device to hand over from the untrusted access point to the trusted access point is transmitted in an RRC Resume Message.

Paragraph 36. A method for providing service continuity in a handover of a communications device from an untrusted access point to a trusted access point in a wireless communications network, the method comprising:
receiving, by transceiver circuitry of the untrusted access point from the communications device, a request to receive a service from a core network of the wireless communications network via the untrusted access point, the communications device being in an inactive state in which it retains a context from a previous communications session with the core network via the trusted access point; providing, by the transceiver circuitry of the untrusted access point to the communications device, the requested service from the core network via the untrusted access point using a current communications session;
determining, by the untrusted access point, that a handover procedure should be performed for the communications device from the untrusted access point to the trusted access point;
arranging, by the untrusted access point, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point.

Paragraph 37. A method according to paragraph 36, wherein the arranging, by the untrusted access point, for the trusted access point to receive information regarding the current communications session used for providing the requested service from the core network to the communications device via the untrusted access point in advance of the handover, comprises
measuring, by control circuitry in the untrusted access point, a quality of radio and transport conditions between the communications device and the untrusted access point when the communications device is receiving the requested service from the untrusted access point;
transmitting, by the transceiver circuitry in the untrusted access point to the core network, an indication of the measured quality of the radio and transport conditions and, in response to receiving the measurements, the core network performs a Quality of Service (QoS) set-up procedure with the trusted access point in which the trusted access point receives the indication that the communications device is currently receiving the requested service from the core network via the untrusted access point.

Paragraph 38. A method according to paragraph 37, wherein the measuring, by the control circuitry in the untrusted access point, the quality of radio and transport conditions between the communications device and the untrusted access point when the communications device is receiving the requested service from the untrusted access point comprises
measuring jitter and packet loss between the communications device and the untrusted access point when the communications device is receiving the requested service from the untrusted access point; and
the transmitting, by the transceiver circuitry in the untrusted access point to the core network, the indication of the measured quality of the radio and transport conditions comprises
transmitting an indication of the measured jitter and packet loss.

Paragraph 39. A communications device for providing service continuity in a handover of the communications device from an untrusted access point to a trusted access point in a wireless communications network, the communications device comprising:
transceiver circuitry configured to transmit and receive signals;
control circuitry configured in combination with the transceiver circuitry to
   transmit to the untrusted access point, a request to receive a service from a core network of the wireless communications network via the untrusted access point, the communications device being in an inactive state in which it retains a context from a previous communications session with the core network via the trusted access point;
   receive, from the untrusted access point, the requested service from the core network via the untrusted access point using a current communications session;
   determine that a handover procedure should be performed for the communications device from the untrusted access point to the trusted access point;
arrange for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
receive the requested service from the core network via the trusted access point after the handover of the communications device from the untrusted access point to the trusted access point.

Paragraph 40. Circuitry in a core network for providing service continuity in a handover of a communications device from an untrusted access point to a trusted access point in a wireless communications network, the circuitry comprising:
transceiver circuitry configured to transmit and receive signals; control circuitry configured in combination with the transceiver circuitry to
receive, from the communications device via the untrusted access point, a request to receive a service from the core network via the untrusted access point, the communications device being in an inactive state in which it retains a context from a previous communications session with the core network via the trusted access point;
provide, to the communications device via the untrusted access point, the requested service using a current communications session;
determine that a handover procedure should be performed for the communications device from the untrusted access point to the trusted access point;
arrange for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
provide the requested service to the communications device via the trusted access point after the handover of the communications device from the untrusted access point to the trusted access point.

Paragraph 41. A trusted access point forming an infrastructure equipment for providing service continuity in a handover of a communications device from an untrusted access point to the trusted access point in a wireless communications network, the trusted access point comprising:
transceiver circuitry configured to transmit and receive signals;
control circuitry configured in combination with the transceiver circuitry to determine that a handover procedure should be performed for the communications device from the untrusted access point to the trusted access point;
receive information regarding a current communications session used for providing a requested service from the core network to the communications device via the untrusted access point in advance of a handover of the communications device between the untrusted and trusted access points, the information regarding the current communications session including at least an indication that the communications device is currently receiving the requested service via the untrusted access point; provide the requested service from the core network via the trusted access point after the handover of the communications device from the untrusted access point to the trusted access point.

Paragraph 42. An untrusted access point forming an infrastructure equipment for providing service continuity in a handover of a communications device from the untrusted access point to a trusted access point in a wireless communications network, the untrusted access point comprising:
transceiver circuitry configured to transmit and receive signals;
control circuitry configured in combination with the transceiver circuitry to receive, from the communications device, a request to receive a service from a core network of the wireless communications network via the untrusted access point, the communications device being in an inactive state in which it retains a context from a previous communications session with the core network via the trusted access point;
provide the requested service from the core network via the untrusted access point using a current communications session;
determine that a handover procedure should be performed for the communications device from the untrusted access point to the trusted access point;
arrange for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point.

Paragraph 43. A system comprising a communications device according to paragraph 39, circuitry in a core network according to paragraph 40, a trusted access point according to paragraph 41 and an untrusted access point according to paragraph 42.

Paragraph 44. A computer program comprising instructions which, when the computer program is executed by a computer, cause the computer to perform a method according to any of paragraphs 1, 18, 24 or 36.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] 3GPP TR 23.793 V16.0.0 (2018-12), “Study on access traffic steering, switch and splitting support in the 5G System (5GS) architecture”, 3^{rd} Generation Partnership Project.
[3] 3GPP TR 23.700-93 v1.2.0, “Study on access traffic steering, switch and splitting support in the 5G System (5GS) architecture; Phase 2”, 3^{rd} Generation Partnership Project.
[4] 3GPP TS 38.331 section 5.3.8.3, “Radio Resource Control (RRC) Specification”, 3rd Generation Partnership Project.

1. A method for providing service continuity in a handover of a communications device from an untrusted access point to a trusted access point in a wireless communications network, the method comprising:
transmitting, by transceiver circuitry of the communications device to the untrusted access point, a request to receive a service from a core network of the wireless communications network via the untrusted access point, the communications device being in an inactive state in which it retains a context from a previous communications session with the core network via the trusted access point;
receiving, by the transceiver circuitry of the communications device from the untrusted access point, the requested service from the core network via the untrusted access point using a current communications session;
determining, by the communications device, that a handover procedure should be performed for the communications device from the untrusted access point to the trusted access point;
arranging, by the communications device, for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
receiving, by the transceiver circuitry of the communications device, the requested service from the core network via the trusted access point after the handover of the communications device from the untrusted access point to the trusted access point.

2. A method according to claim 1, wherein the arranging, by the communications device, for the trusted access point to receive information regarding the current communications session used for providing the requested service from the core network to the communications device via the untrusted access point in advance of the handover, comprises
measuring, by control circuitry in the communications device, a quality of radio and transport conditions between the communications device and the untrusted access point when the communications device is receiving the requested service from the untrusted access point;
transmitting, by the transceiver circuitry in the communications device to the core network, an indication of the measured quality of the radio and transport conditions and, in response to receiving the measurements, the core network performs a Quality of Service (QoS) set-up procedure with the trusted access point in which the trusted access point receives the indication that the communications device is currently receiving the requested service from the core network via the untrusted access point.

3. A method according to claim 2, wherein the transmitting, by the transceiver circuitry in the communications device, the indication of the measured quality of the radio and transport conditions to the trusted access point comprises,
including, by control circuitry in the communications device, the indication of the measured quality of the radio and transport conditions in a Wireless Local Area Network (WLAN) Status indication message;
transmitting, by the transceiver circuitry in the communications device, the WLAN to the trusted access point for forwarding onto the core network.

4. A method according to claim 2, wherein the transmitting, by the transceiver circuitry in the communications device, the indication of the measured quality of the radio and transport conditions to the trusted access point comprises,
including, by control circuitry in the communications device, the indication of the measured quality of the radio and transport conditions in an RRC Resume message;
transmitting, by the transceiver circuitry in the communications device, the RRC Resume message to the trusted access point for forwarding onto the core network.

5. A method according to claim 1, wherein the measuring, by the control circuitry in the communications device, the quality of radio and transport conditions between the communications device and the untrusted access point when the communications device is receiving the requested service from the untrusted access point comprises
measuring jitter and packet loss between the communications device and the untrusted access point when the communications device is receiving the requested service from the untrusted access point; and
the transmitting, by the transceiver circuitry in the communications device to the core network, the indication of the measured quality of the radio and transport conditions comprises
transmitting an indication of the measured jitter and packet loss.

6. A method according to claim 1, wherein the transmitting, by the transceiver circuitry of the communications device to the untrusted access point, the request to receive the service from the core network of the wireless communications network via the untrusted access point comprises
submitting, by a non-access stratum (NAS) protocol layer in the communications device, the request for receiving the service to an access (AS) protocol layer in the communications device and the transceiver circuitry of the communications device transmitting the request to receive the service in response.

7. A method according to claim 1, wherein the arranging, by the communications device, for the trusted access point to receive information regarding the current communications session used for providing the requested service from the core network to the communications device via the untrusted access point in advance of the handover, comprises
transmitting, by the transceiver circuitry in the communications device to the trusted access point, a request that the communications device remains in the inactive state including the indication that the communications device is currently receiving the request service from the core network via the untrusted access point;
receiving, by the transceiver circuitry in the communications device from the trusted access point, an instruction to remain in the inactive state.

8. A method according to claim 7, wherein the transmitting, by the transceiver circuitry in the communications device to the trusted access point, the request that the communications device remains in the inactive state comprises
including, by control circuitry in the communications device, a cause value in an RRC Resume Request message indicating that the communications device wishes to remain in the inactive state;
transmitting, by transceiver circuitry in the communications device to the trusted access point, the RRC Resume Request message; and the receiving, by the transceiver circuitry in the communications device from the trusted access point, the instruction to remain in the inactive state comprises
receiving, by the transceiver circuitry in the communications device from the trusted access point, an RRC Resume message including an instruction to remain in the inactive state.

9. A method according to claim 1, comprising
measuring, by the control circuitry in the communications device, a quality of radio conditions between the communications device and the untrusted access point when the communications device is receiving the requested service from the untrusted access point; and wherein the determining, by the communications device, that the handover procedure should be performed for the communications device from the untrusted access point to the trusted access point comprises:
detecting, by the control circuitry in the communications device, based on the measurements of the quality of the radio conditions, that the quality of the radio conditions are below a pre-defined threshold and, in response,
transmitting, by the transceiver circuitry in the communications device, an indication to the trusted access point that the communications device should be handed over from the untrusted access point to the trusted access point.

10. A method according to claim 9, wherein the transmitting, by the transceiver circuitry in the communications device, the indication to the trusted access point that the communications device should be handed over from the untrusted access point to the trusted access point comprises
including, by the control circuitry in the communications device, a cause value in a second RRC Resume Request message indicating that the communications device should handover from the untrusted access point to the trusted access point;
transmitting, by the transceiver circuitry in the communications device, the second RRC Request message to the trusted access point.

11. A method according to claim 9, wherein the measuring, by the control circuitry in the communications device, the quality of the radio conditions between the communications device and the untrusted access point when the communications device is receiving the requested service from the untrusted access point comprises
measuring one or more of a signal to noise plus interference (SINR) ratio, reference signal received power (RSRP), reference signal received quality (RSRQ) or block error rate (BLER) and the detecting, by the control circuitry in the communications device, based on the measurements of the quality of the radio conditions, that the quality of the radio conditions are below a pre-defined threshold comprises detecting that the measured one or more of the measured SINR, RSRP, RSRQ or BLER is below a pre-defined threshold.

12. A method according to claim 1, wherein the determining, by the communications device, that the handover procedure should be performed for the communications device from the untrusted access point to the trusted access point comprises
receiving an indication from the core network via the trusted access point that the handover procedure should be performed for the communications device from the untrusted access point to the trusted access point.

13. A method according to claim 1, wherein the non-trusted access point is a base station forming part of a stand-alone non-public network (SNPN).

14. A method according to claim 1, wherein the non-trusted access point is a residential gateway implementing WiFi protocols for radio communication.

15. A method according to claim 1, wherein the trusted access point is infrastructure equipment forming part of the wireless communications network.

16. A method according to claim 1, wherein the current communications session is a Multi-Access Protocol Data Unit (MA-PDU) session.

17. A method according to claim 1, wherein the requested service is a Guaranteed Bit Rate (GBR) service.

18.-38. (canceled)

39. A communications device for providing service continuity in a handover of the communications device from an untrusted access point to a trusted access point in a wireless communications network, the communications device comprising:
transceiver circuitry configured to transmit and receive signals;
control circuitry configured in combination with the transceiver circuitry to
transmit to the untrusted access point, a request to receive a service from a core network of the wireless communications network via the untrusted access point, the communications device being in an inactive state in which it retains a context from a previous communications session with the core network via the trusted access point;
receive, from the untrusted access point, the requested service from the core network via the untrusted access point using a current communications session;
determine that a handover procedure should be performed for the communications device from the untrusted access point to the trusted access point;
arrange for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
receive the requested service from the core network via the trusted access point after the handover of the communications device from the untrusted access point to the trusted access point.

40. Circuitry in a core network for providing service continuity in a handover of a communications device from an untrusted access point to a trusted access point in a wireless communications network, the circuitry comprising:
transceiver circuitry configured to transmit and receive signals;
control circuitry configured in combination with the transceiver circuitry to
receive, from the communications device via the untrusted access point, a request to receive a service from the core network via the untrusted access point, the communications device being in an inactive state in which it retains a context from a previous communications session with the core network via the trusted access point;
provide, to the communications device via the untrusted access point, the requested service using a current communications session;
determine that a handover procedure should be performed for the communications device from the untrusted access point to the trusted access point;
arrange for the trusted access point to receive information regarding the current communications session used for providing the requested service from the core network to the communications device via the untrusted access point in advance of the handover, the information regarding the current communications session including at least an indication that the communications device is currently receiving the requested service via the untrusted access point;
provide the requested service to the communications device via the trusted access point after the handover of the communications device from the untrusted access point to the trusted access point.

41.-44. (canceled)
